(19) United States
(12) Patent Application Publication
(10) Pub. No.: US 2011/0257067 A1
(43) Pub. Date: Oct. 20, 2011

(54) Process for Making a Detergent

(76) Inventors: Nigel Patrick Somerville Roberts, Newcastle upon Tyne (GB); Hossam Hassan Tantawy, Northumberland (GB); Eric San Jose Robles, Newcastle upon Tyne (GB); Marc Stephen Bardsley, Newcastle upon Tyne (GB)

(21) Appl. No.: 13/086,621

(22) Filed: Apr. 14, 2011

(30) Foreign Application Priority Data
Apr. 19, 2010 (EP) 10160345.4

(51) Int. Cl. C11D 1/37

(52) U.S. Cl. 510/352

(57) ABSTRACT

A process for making a detergent composition including the step of forming a low-water-containing surfactant mixture including: i) a hexagonal-phase-in-water-forming surfactant; and ii) a sulphonate detersive surfactant.

### FIELD OF THE INVENTION

The present invention relates to a process for making a detergent composition. In particular it relates to a process comprising the step of making a low-water-containing surfactant mixture.

### BACKGROUND OF THE INVENTION

The handling of surfactants during a manufacturing process for making a detergent can be challenging due to the formation of different surfactant phases that alter the physical properties of surfactants, in particular rheology and make their handling and processing, including spray-drying and agglomeration, difficult. Surfactants can also interact with other detergent ingredients and impair on the flowability and solubility of the finished detergent. The interaction of surfactants with other detergent ingredients can also impair on the availability during the cleaning process of the surfactant and/or other detergent ingredients, negatively influencing on the cleaning performance.

An objective of the present invention is to provide a flexible, versatile and simple process for the production of detergents. Another objective of the present invention is to provide a detergent composition with improved physical properties that provides improved cleaning.

### SUMMARY OF THE INVENTION

According to a first aspect of the invention, there is provided a process for making a detergent composition. The process comprises the step of forming a low-water-containing surfactant mixture. By “low-water-containing surfactant mixture” is herein understood a mixture of surfactants, the mixture having preferably less than 30%, more preferably less than 20% and especially less than 10% of water by weight of the mixture. Preferably the mixture is free of any other detergent ingredients. By “free of any other detergent ingredients” is herein understood that the mixture comprises less than 10%, more preferably less than 5% and especially less than 1% by weight of the mixture of detergent ingredients other than surfactants.

The low-water-containing surfactant mixture comprises a hexagonal-phase-in-water-forming surfactant (also referred to herein as first surfactant) and a sulphonate detersive surfactant (also referred herein to as second surfactant). The mixture presents favorable rheology thereby facilitating in-plant handling.

By “hexagonal-phase-in-water-forming surfactant” is herein understood a surfactant that would form hexagonal phase when mixed with water in an amount of from about 20% to about 70% of surfactant by weight of the mixture in a range temperature of from about 20° C. to about 95° C. The hexagonal phase can be detected using a polarized light microscope (see for example, The Aqueous Phase Behavior of Surfactant, R. Laughlin, Academic Press 1994, pp. 538-542) and/or x-ray diffraction (XRD) and/or small angle x-ray scattering (SAXS) (see for example, A. Svensson, et al, J. Phys. Chem. B, 106, 1013 (2002); K. Fontell, Colloid Poly. Sci. 268, 264 (1990); F. Muller, et al, Colloids Surf A, 358, (2010), 50-56.). The diffraction pattern of the hexagonal liquid crystalline lattices exhibits Bragg peaks with the relative d-value ratios of 1:1√3:1/√4:1/√7:1/√9 for the diffraction planes or Miller's indices {hkl} of {1 0}, {1 1}, {2 0}, {2 1}, {3 0}, respectively.

Surfactants being in the hexagonal phase usually present a challenging rheology, they tend to be highly viscous, this makes their handling in plants very difficult, costly and in some occasions impossible to handle. This is especially detrimental when spray-drying or agglomeration is involved. The surfactant can become so viscous that it could block the spray nozzles and it can be impossible to atomize.

It has been surprisingly found that if the first and second surfactants are mixed, preferably in the absence of high levels of water and preferably in the absence of any other detergent ingredients, the formation of a viscous phase can be avoided and the resulting mixture has a very favorable rheology from a handling view point. It has also been found that detergents made with this mixture provide better cleaning than detergents with the same composition in which the surfactants have not been mixed in the absence of high level of water and preferably in the absence of other detergent ingredients. Without wishing to be bound by theory, it is believed that the mixing of the first and second surfactants avoids the formation of the hexagonal phase and leads to the formation of a phase that is robust enough to be kept even when diluted with water or when neutralized.

Preferably the first and second surfactants are mixed at the molecular level, i.e. the combination of the molecules of the two surfactants forms one phase rather than a dispersion of one surfactant into the other surfactant. The mixture can be obtained by any known mixing equipment

In a preferred embodiment of the invention, the surfactant mixture is in the form of mixed inverted micelles. This appears as an isotropic liquid under polarized light microscope and non-conductive when analysed with a conductivity meter (see for example, B. Paul and R. Mitra, J. Colloid Interface Scie. 288, (2005), 261-279 or M. Sedgwick, et al, Langmuir (2009) 25, 5496-5503)). This facilitates the handling during the manufacture process.

In preferred embodiments the first and second surfactants are in a weight ratio of from about 60:40 to about 1:100, more preferably from about 50:50 to about 40:60.

Preferred hexagonal-phase-in-water-forming surfactants include sulphate detersive surfactants. Especially preferred for use herein are sulphate detersive surfactants, in particular alkyl ethoxylated sulphates and more in particular a C₈₋₁₈ alkyl ethoxylated sulphate having an average degree of ethoxylation of from 0.5 to 10, preferably from 0.5 to 7, more preferably from 0.5 to 5 and most preferably from 0.5 to 3.

In a preferred embodiment the surfactant mixture comprises a cationic surfactant.

From a process view point it is preferred that at least one of the surfactants, more preferably the first and second surfactants are mixed in acid form.

Preferably, the detergent resulting form the process of the invention is in powder form. In preferred embodiments the process of the invention comprises the step of forming an aqueous slurry (i.e. comprising more than 10%, more preferably more than 15% and especially more than 20% of water by weight of the slurry) comprising detergent ingredients and preferably free of hexagonal-phase-in-water-forming surfactant (i.e. comprising less than 5%, more preferably less than 3% and especially less than 1% of surfactant by weight of the slurry), more preferably free of any surfactant. Preferably the aqueous slurry is mixed with the surfactant mixture and the resulting mixture is then spray-dried.

In another embodiment, the surfactant mixture undergoes an agglomeration step. The mixture is very suitable for agglomeration due to its lack of stickiness among other advantages.

According to a second aspect of the invention, there is provided low-water-containing surfactant mixture comprising: i) a hexagonal-phase-in-water-forming surfactant: and ii) a sulphonate detersive surfactant. All the features and advantages of the surfactant mixture described herein for the surfactant mixture of the process of the invention apply mutatis mutandis to the mixture of the second aspect of the invention.

According to a third aspect of the invention, there is provided a detergent composition obtainable, preferably obtained, according to the process of the invention, preferably the detergent is a laundry detergent. The detergent composition presents improved solubility and cleaning over detergents with the same composition obtained by a different manufacturing process. It seems that when the first and second surfactants are mixed at a molecular level, this improves solubility and it is translated into improved cleaning.

### DETAILED DESCRIPTION OF THE INVENTION

The present invention envisages a process for making a detergent composition comprising the step of forming a low-water-containing surfactant mixture. The mixture has a very favorable rheology that improves handleability of the surfactants. The invention also envisages a surfactant mixture and a detergent composition obtainable according to the process of the invention. The composition presents improved solubility and provides cleaning benefits.

The key step in the process of the invention is the formation of a low-water-containing surfactant mixture comprising: i) a hexagonal-phase-in-water-forming surfactant: and ii) a sulphonate detersive surfactant. The mixture can be obtained by any known mixing equipment. Preferably the mixing occurs at a molecular level and the surfactant in the resulting mixture presents an inverted micellar phase structure.

### First Surfactant

Preferred surfactants for use herein as first surfactant include sulphate detersive surfactants, more preferably an alkyl sulphate and especially a C₈₋₁₈ alkyl sulphate, or predominantly C₁₂ alkyl sulphate.

A preferred sulphate detersive surfactant is alkyl alkoxylated sulphate, preferably alkyl ethoxylated sulphate, preferably a C₈₋₁₈ alkyl alkoxylated sulphate, preferably a C₈₋₁₈ alkyl ethoxylated sulphate, preferably the alkyl alkoxylated sulphate has an average degree of alkoxylation of from 0.5 to 20, preferably from 0.5 to 10, preferably the alkyl alkoxylated sulphate is a C₈₋₁₈ alkyl ethoxylated sulphate having an average degree of ethoxylation of from 0.5 to 10, preferably from 0.5 to 7, more preferably from 0.5 to 5 and most preferably from 0.5 to 3.

### Second Surfactant

Preferred surfactants for use herein as second surfactant include sulphonate detersive surfactants, in particular alkyl benzene sulphonate, preferably C₁₀₋₁₃ alkyl benzene sulphonate. Suitable alkyl benzene sulphonate (LAS) is obtainable, preferably obtained, by sulphonating commercially available linear alkyl benzene (LAB); suitable LAB includes low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®. A suitable second surfactant is alkyl benzene sulphonate that is obtained by DETAL catalyzed process, although other synthesis routes, such as HF, may also be suitable.

The first and/or second surfactants may be linear or branched, substituted or un-substituted. The first and/or second surfactants may be a mid-chain branched detersive surfactant, preferably the first surfactant is a mid-chain branched alkyl sulphate and/or the second surfactant is a mid-chain branched alkyl benzene sulphonate, most preferably a mid-chain branched alkyl sulphate. Preferably, the mid-chain branches are C₁₋₄ alkyl groups, preferably methyl and/or ethyl groups.

The surfactant mixture may comprise a graft co-polymer (more preferably the graft co-polymer is a random graft co-polymer). This kind of polymer can hydrolyse under high pH and high temperature. Graft co-polymers are stable in the surfactant mixture.

Random Graft Co-Polymer

The random graft co-polymer typically comprises: (i) hydrophilic backbone comprising monomers selected from the group consisting of: unsaturated C₁-C₆ carboxylic acids, ethers, alcohols, aldehydes, ketones, esters, sugar units, alkoxy units, maleic anhydride, saturated polyalcohols such as glycerol, and mixtures thereof; and (ii) hydrophobic side chain(s) selected from the group consisting of: C₄-C₂₅ alkyl group, polypropylene, polybutylene, vinyl ester of a saturated C₁-C₆ mono-carboxylic acid, C₁-C₆ alkyl ester of acrylic or methacrylic acid, and mixtures thereof.

The polymer preferably has the general formula:

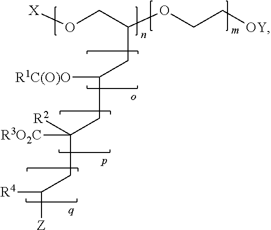

wherein X, Y and Z are capping units independently selected from H or a C₁₋₆ alkyl; each R¹ is independently selected from methyl and ethyl; each R² is independently selected from H and methyl; each R³ is independently a C₁₋₄ alkyl; and each R⁴ is independently selected from pyrrolidone and phenyl groups. The weight average molecular weight of the polyethylene oxide backbone is typically from about 1,000 g/mol to about 18,000 g/mol, or from about 3,000 g/mol to about 13,500 g/mol, or from about 4,000 g/mol to about 9,000 g/mol. The value of m, n, o, p and q is selected such that the pendant groups comprise, by weight of the polymer at least 50%, or from about 50% to about 98%, or from about 55% to about 95%, or from about 60% to about 90%. The polymer useful herein typically has a weight average molecular weight of from about 1,000 to about 100,000 g/mol, or preferably from about 2,500 g/mol to about 45,000 g/mol, or from about 7,500 g/mol to about 33,800 g/mol, or from about 10,000 g/mol to about 22,500 g/mol.

Suitable graft co-polymers are described in more detail in WO07/138,054, WO06/108856 and WO06/113314.

### Aqueous Slurry

The aqueous detergent slurry typically comprises detergent ingredients, such as alkalinity source, polymer, builder, filler salts and mixtures thereof. It may also be especially preferred for the aqueous detergent slurry to comprise low levels, or even be free, of builder.

Preferably, the aqueous detergent slurry comprises from 0 wt % to 10 wt %, or to 9 wt %, or to 8 wt %, or to 7 wt %, or to 6 wt %, or to 5 wt %, or to 4 wt %, or to 3 wt %, or to 2 wt %, or to 1 wt % zeolite builder. Preferably, the aqueous detergent slurry is essentially free of zeolite builder.

Preferably, the aqueous detergent slurry comprises from 0 wt % to 10 wt %, or to 9 wt %, or to 8 wt %, or to 7 wt %, or to 6 wt %, or to 5 wt %, or to 4 wt %, or to 3 wt %, or to 2 wt %, or to 1 wt % phosphate builder. Preferably, the aqueous detergent slurry is essentially free of phosphate builder.

Preferably the aqueous detergent slurry is alkaline. Preferably, the aqueous detergent slurry has a pH of greater than 7.0, preferably greater than 7.7, or greater than 8.1, or even greater than 8.5, or greater than 9.0, or greater than 9.5, or greater than 10.0, or even greater than 10.5, and preferably to 14, or to 13, or to 12.

### Process for Preparing a Spray-Dried Detergent Powder

The process for preparing a spray-dried detergent powder typically comprises the steps of: (a) forming an aqueous detergent slurry in a mixer; (b) transferring the aqueous detergent slurry from the mixer through at least one pump to a spray nozzle; (c) forming the low-water-containing surfactant mixture and contacting it to the aqueous detergent slurry after the mixer and before the spray nozzle to form a mixture; (d) spraying the mixture through the spray nozzle into a spray-drying tower; and (e) spray-drying the mixture to form a spray-dried powder.

Step (a): the aqueous detergent slurry can be formed by mixing in any suitable vessel, such as mixer, in the standard manner. Suitable mixers include vertical mixers, slurry mixers, tank agitators, crutcher mixers and the like.

Step (b): the aqueous detergent slurry is transferred from the mixer through at least one pump to a spray nozzle. Typically, the aqueous detergent slurry is transferred in a pipe. The aqueous slurry is typically transferred though an intermediate storage vessel such as a drop tank, for example when the process is semi-continuous. Alternatively, the process can be a continuous process, in which case no intermediate storage vessel is required. The aqueous detergent slurry is transferred through at least one pump, preferably at least two, or even at least three or more pumps, although one or two, preferably two pumps may be preferred. Typically, when two or more pumps are used, the first pump is a low pressure pump, such as a pump that is capable of generating a pressure of from 3×10⁵ to 1×10⁶ Pa, and the second pump is a high pressure pump, such as a pump that is capable of generating a pressure of from 2×10⁶ to 1×10⁷ Pa. Optionally, the aqueous detergent slurry is transferred through a disintegrator, such as disintegrators supplied by Hosakawa Micron. The disintegrator can be position before the pump, or after the pump. If two or more pumps are present, then the disintegrator can also be positioned between the pumps. Typically, the pumps, disintegrators, intermediate storage vessels, if present, are all in series configuration. However, some equipment may be in a parallel configuration. A suitable spray nozzle is a Spray Systems T4 Nozzle.

Step (c): a hexagonal-phase-in-water-forming surfactant: and a sulphonate detersive surfactant are mixed to form the low-water-containing surfactant mixture. The resulting surfactant mixture and/or acid precursor thereof is contacted to the aqueous detergent slurry after the mixer and before the spray nozzle to form a mixture. Step (c) can be carried out in any position after the mixer and before the spray nozzle. However, preferably step (c) is carried out after the aqueous detergent slurry has been transferred through at least one pump, although step (c) may be carried out before the aqueous detergent slurry has been transferred through at least one pump. In a preferred embodiment, the aqueous detergent slurry is transferred through at least two pumps, and step (c) is carried out after the aqueous detergent slurry has been transferred through the first pump but before the aqueous detergent slurry enters the second pump. Preferably, during step (c) the pipe is at a pressure of from 3×10⁵ to 1×10⁶ Pa. However, it may be preferred for step (c) to be carried out immediately before the spray nozzle.

In step (c), it may be preferred that a neutralizer agent (such as sodium hydroxide) is contacted to the aqueous detergent slurry after the mixer and before the spray nozzle.

Step (d): the mixture formed in step (c) is sprayed through the spray nozzle into a spray-drying tower. Preferably, the mixture is at a temperature of from 60° C. to 130° C. when it is sprayed through the spray nozzle into a spray-drying tower. Suitable spray-drying towers are co-current or counter-current spray-drying towers. The mixture is typically sprayed at a pressure of from 6×10⁶ Pa to 1×10⁷ Pa.

Step (e): the mixture is spray-dried to form a spray-dried powder. Preferably, the exhaust air temperature is in the range of from 60° C. to 100° C.

### Detergent Composition

Preferably the detergent composition obtained or obtainable according to the process of the invention comprises (by weight of the composition):

(a) from 0 wt % to 10 wt % zeolite builder;

(b) from 0 wt % to 10 wt % phosphate builder; and

(c) optionally from 0 wt % to 15 wt % silicate salt.

Zeolite Builder

Suitable zeolite builder includes include zeolite A, zeolite P and zeolite MAP. Especially suitable is zeolite 4A.

### Phosphate Builder

A typical phosphate builder is sodium tri-polyphosphate.

### Silicate Salt

A suitable silicate salt is sodium silicate, preferably 1.6R and/or 2.0R sodium silicate.

### Other Detergent Ingredients

The composition typically comprises other detergent ingredients. Suitable detergent ingredients include: transition metal catalysts; imine bleach boosters; enzymes such as amylases, carbohydrases, cellulases, laccases, lipases, bleaching enzymes such as oxidases and peroxidases, proteases, pectate lyases and mannanases; source of peroxygen such as percarbonate salts and/or perborate salts, preferred is sodium percarbonate, the source of peroxygen is preferably at least partially coated, preferably completely coated, by a coating ingredient such as a carbonate salt, a sulphate salt, a silicate salt, borosilicate, or mixtures, including mixed salts, thereof; bleach activator such as tetraacetyl ethylene diamine, oxybenzene sulphonate bleach activators such as nonanoyl oxybenzene sulphonate, caprolactam bleach activators, imide bleach activators such as N-nonanoyl-N-methyl acetamide, preformed peracids such as N,N-pthaloylamino peroxycaproic acid, nonylamido peroxyadipic acid or dibenzoyl peroxide; suds suppressing systems such as silicone based suds suppressors and/or fatty acid based suds suppressors; brighteners; hueing agents; photobleach; fabric-softening agents such as clay, silicone and/or quaternary ammonium compounds; flocculants such as polyethylene oxide; dye transfer inhibitors such as polyvinylpyrrolidone, poly 4-vinylpyridine N-oxide and/or co-polymer of vinylpyrrolidone and vinylimidazole; fabric integrity components such as oligomers produced by the condensation of imidazole and epichlorhydrin; soil dispersants and soil anti-redeposition aids such as alkoxylated polyamines and ethoxylated ethyleneimine polymers; anti-redeposition components such as polyesters and/or terephthalate polymers, polyethylene glycol including polyethylene glycol substituted with vinyl alcohol and/or vinyl acetate pendant groups; perfumes such as perfume microcapsules, polymer assisted perfume delivery systems including Schiff base perfume/polymer complexes, starch encapsulated perfume accords; soap rings; aesthetic particles including coloured noodles and/or needles; dyes; fillers such as sodium sulphate, although it may be preferred for the composition to be substantially free of fillers; carbonate salt including sodium carbonate and/or sodium bicarbonate; silicate salt such as sodium silicate, including 1.6R and 2.0R sodium silicate, or sodium metasilicate; co-polyesters of di-carboxylic acids and diols; cellulosic polymers such as methyl cellulose, carboxymethyl cellulose, hydroxyethoxycellulose, or other alkyl or alkylalkoxy cellulose, and hydrophobically modified cellulose; carboxylic acid and/or salts thereof, including citric acid and/or sodium citrate; and any combination thereof.

### EXAMPLES

### Example 1

### A Spray-Dried Laundry Detergent Powder and Process of Making it

### Aqueous Alkaline Slurry Composition.

| Component | Aqueous slurry (parts) |
|---|---|
| Sodium Silicate | 8.5 |
| Acrylate/maleate copolymer | 3.2 |
| Hydroxyethane di(methylene phosphonic acid) | 0.6 |
| Sodium carbonate | 8.8 |
| Sodium sulphate | 42.9 |
| Water | 19.7 |
| Miscellaneous, such as magnesium sulphate, | 1.7 |
| and one or more stabilizers | |
| Aqueous alkaline slurry parts | 85.4 |

### Preparation of a Spray-Dried Laundry Detergent Powder.

An alkaline aqueous slurry having the composition as described above is prepared in a slurry making vessel (crutcher). The alkaline aqueous slurry is shear thinning and has a viscosity in the range of from 0.5 to 30 Pas at a temperature of 70° C. and at a shear rate of 50 s⁻¹. The moisture content of the above slurry is 23.1%. Any ingredient added above in liquid form is heated to 70° C., such that the aqueous slurry is never at a temperature below 70° C. Saturated steam at a pressure of 6.0×10⁵ Pa is injected into the crutcher to raise the temperature to 90° C. The slurry is then pumped into a low pressure line (having a pressure of 5.0×10⁵ Pa).

1.14 parts of ethoxylated C₁₂₋₁₈ alkyl alcohol sulphate anionic detersive surfactant having an average degree of ethoxylation of 1 (AE₁S) and 10.26 parts of C₈-C₂₄ alkyl benzene sulphonic acid (HLAS) are pumped through a static mixer (Sulzer Chemtech SMX type) that effectively homogenize the surfactants. The line pressure ranges from 12.0×10⁵ Pa to 8.0×10⁵ Pa upstream of the static mixer. This homogenized surfactant mixture is pumped into the low pressure line. 3.2 parts of a 50 w/w % aqueous sodium hydroxide solution is pumped separately and simultaneous with the homogenized surfactant mixture into the low pressure line.

The resultant mixture is then pumped by a high pressure pump into a high pressure line (having an exit pressure of 8.0×10⁶ Pa). The mixture is then sprayed at a rate of 1,640 kg/hour at a pressure of 8.0×10⁶ Pa and at a temperature of 90° C.+/−2° C. through a spray pressure nozzle into a counter current spray-drying tower with an air inlet temperature of 300° C. The mixture is atomised and the atomised slurry is dried to produce a solid mixture, which is then cooled and sieved to remove oversize material (>1.8 mm) to form a spray-dried powder, which is free-flowing. Fine material (<0.15 mm) is elutriated with the exhaust the exhaust air in the spray-drying tower and collected in a post tower containment system. The composition of the spray-dried powder is given below.

### Spray-Dried Laundry Detergent Powder Composition

| Component | % w/w Spray Dried Powder |
|---|---|
| Ethoxylated C₁₂₋₁₈ alkyl alcohol sulphate | 1.5 |
| anionic detersive surfactant having an | |
| average degree of ethoxylation of 1 (AE₁S) | |
| Sodium silicate salt | 10.0 |
| C₈-C₂₄ alkyl benzene sulphonate | 13.6 |
| Acrylate/maleate copolymer | 4.0 |
| Hydroxyethane di(methylene phosphonic acid) | 0.7 |
| Sodium carbonate | 11.9 |
| Sodium sulphate | 53.7 |
| Water | 2.5 |
| Miscellaneous, such as magnesium | 2.1 |
| sulphate, and one or more stabilizers | |
| Total Parts | 100.00 |

### A Granular Laundry Detergent Composition.

| | % w/w granular |
|---|---|
| | laundry detergent |
| Component | composition |
| Spray-dried powder of example 1 (described above) | 59.38 |
| 91.6 wt % active linear alkyl benzene sulphonate flake | 0.22 |
| supplied by Stepan under the tradename Nacconol 90G ® | |
| Citric acid | 5.00 |
| Sodium percarbonate (having from 12% to 15% | 14.70 |
| active AvOx) | |
| Photobleach particle | 0.01 |
| Lipase (11.00 mg active/g) | 0.70 |
| Amylase (21.55 mg active/g) | 0.33 |
| Protease (56.00 mg active/g) | 0.43 |
| Tetraacetyl ethylene diamine agglomerate (92 wt % active) | 4.35 |
| Suds suppressor agglomerate (11.5 wt % active) | 0.87 |
| Acrylate/maleate copolymer particle (95.7 wt % active) | 0.29 |
| Green/Blue carbonate speckle | 0.50 |
| Sodium Sulphate | 9.59 |
| Solid perfume particle | 0.63 |
| Ethoxylated C₁₂-C₁₈ alcohol having an average | 3.00 |
| degree of ethoxylation of 7 (AE7) | |
| Total Parts | 100.00 |

The above laundry detergent composition was prepared by dry-mixing all of the above particles (all except the AE7) in a standard batch mixer. The AE7 in liquid form is sprayed on the particles in the standard batch mixer. Alternatively, the AE7 in liquid form is sprayed onto the spray-dried powder of example 1. The resultant powder is then mixed with all of the other particles in a standard batch mixer.

### Example 2

### Alomeration of a Surfactant Mixture

106.9 g of 70% active C24AE3S (ethoxylated C₁₂₋₁₄ alkyl alcohol sulphate anionic detersive surfactant having an average degree of ethoxylation of 3) paste is mixed into 254.2 g of HLAS (alkyl benzene sulphonate) with stirring by hand. After initially forming a slightly thicker gel, this mixture rapidly becomes an isotropic, uniform, clear mix.

237 g of micronised light carbonate (d50=14 microns) is put in a kitchen food mixer. 156.0 g of the HLAS/AE3S blend is added to the ground light carbonate over 1 minute with the mixer at maximum speed. The resulting agglomerates have a white, uniform appearance with no residual HLAS odour and are sieved through a 1.7 mm sieve to give agglomerates of the following composition.

| | |
|---|---|
| Carbonate | 56.9% |
| LAS | 31.1% |
| AE3S | 8.4% |
| Water | 3.6% |

These agglomerates are then dried in a well-fluidised fluid bed dryer with air at 90° C. for 5 minutes to give free-flowing agglomerates with the following composition.

| | |
|---|---|
| Carbonate | 58.4% |
| LAS | 32.0% |
| AE3S | 8.6% |
| Water | 1.0% |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for making a detergent composition comprising the step of forming a low-water-containing surfactant mixture comprising: i) a hexagonal-phase-in-water-forming surfactant; and ii) a sulphonate detersive surfactant.

2. A process according to claim 1 wherein the surfactant mixture involves molecular mixing of the hexagonal-phase-in-water-forming surfactant and the sulphonate detersive surfactant.

3. A process according to claim 1 wherein the surfactant mixture is in the form of mixed inverted micelles.

4. A process according to claim 1 wherein the hexagonal-phase-in-water-forming surfactant and the sulphonate detersive surfactant are in a weight ratio of from about 60:40 to about 1:100.

5. A process according to claim 1 wherein the hexagonal-phase-in-water-forming surfactant is a sulphate detersive surfactant.

6. A process according to claim 5 wherein the sulphate detersive surfactant is an alkyl alkoxylated sulphate.

7. A process according to claim 1 wherein the surfactant mixture further comprises a graft copolymer.

8. A process according to claim 1 wherein the surfactant mixture further comprises a cationic surfactant.

9. A process according to claim 1 wherein at least one of the surfactants is in acid form.

10. A process according to claim 1 wherein the detergent composition is in powder form.

11. A process according to claim 1 wherein the surfactant mixture undergoes an agglomeration step.

12. A process according to claim 1 comprising the step of forming an aqueous slurry comprising detergent ingredients and preferably free of hexagonal-phase-in-water-forming surfactant and mixing the aqueous slurry with the surfactant mixture.

13. A process according to claim 12 comprising the step of spray-drying the resulting mixture.

14. A low-water-containing surfactant mixture comprising: i) a hexagonal-phase-in-water-forming surfactant: and ii) a sulphonate detersive surfactant.

15. Detergent composition obtainable according to the process of claim 1.
